(19) United States
(12) Patent Application Publication
(10) Pub. No.: US 2013/0179776 A1
(43) Pub. Date: Jul. 11, 2013

(54) Enabling Performant Cascading Operations

(71) Applicants: Jacob S. Rossi, Seattle, WA (US); Justin E. Rogers, Redmond, WA (US); Nathan J.E. Furtwangler, Seattle, WA (US)

(72) Inventors: Jacob S. Rossi, Seattle, WA (US); Justin E. Rogers, Redmond, WA (US); Nathan J.E. Furtwangler, Seattle, WA (US)

(73) Assignee: Microsoft Corporation, Redmond, WA (US)

(21) Appl. No.: 13/363,046

(22) Filed: Jan. 31, 2012

(30) Foreign Application Priority Data
Jan. 6, 2012 (CA) 2763316

(51) Int. Cl. G06F 17/00

(52) U.S. Cl. 715/236; 715/234

(57) ABSTRACT

Various embodiments enable performant cascading operations to be performed by selectively applying a subset of cascading operations to designated elements in a hierarchical tree, responsive to receiving an input associated with one of the elements. A full set of cascading operations can be performed, subsequent to performing the subset of cascading operations, in accordance with various parameters. Such parameters can include, by way of example and not limitation, user interaction timing, the complexities of the cascading operations for a given element, and/or the number of elements to which the cascading operations can be applied, to name just a few.

### PRIORITY CLAIM

This application claims priority under 35 U.S.C. § 119 to Canadian Patent Application Serial No. 2,763,316 (Attorney Docket Number: 335245.01) filed in Canada on Jan. 6, 2012 and titled “Enabling Performant Cascading Operations,” the disclosure of which is incorporated by reference in its entirety herein.

### BACKGROUND

One challenge faced by those who design content that can be consumed over the web is to enable such content to run in a perceivably fast way on various types of devices, including those types of devices that may not necessarily be designed to run in a correspondingly fast manner. For example, web content is typically represented in a hierarchical document object model (DOM) tree including elements that have descendent elements and ancestor elements.

Often times when input is received with respect to a particular element, that input can be used as a basis to “tunnel” or cascade an associated behavior or fire events up the hierarchical tree to other ancestor elements. For large trees, determining which elements on which to apply a particular behavior can be an expensive operation. Accordingly, challenges continue to exist to ensure that the user's experience is efficient and well-perceived.

### SUMMARY

This Summary is provided to introduce a selection of concepts in a simplified form that are further described below in the Detailed Description. This Summary is not intended to identify key features or essential features of the claimed subject matter.

Various embodiments enable performant cascading operations to be performed by selectively applying a subset of cascading operations to designated elements in a hierarchical tree, responsive to receiving an input associated with one of the elements. A full set of cascading operations can be performed, subsequent to performing the subset of cascading operations, in accordance with various parameters.

In one or more embodiments, the subset of cascading operations can be determined, for the received input, based on parameters including, by way of example and not limitation, user interaction timing, the complexities of the cascading operations for a given element, and/or the number of elements to which the cascading operations can be applied, to name just a few.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 illustrates an example embodiment in which cascading operations can be applied.

FIG. 4 illustrates an example embodiment in which cascading operations can be applied.

FIG. 5 illustrates an example embodiment in which cascading operations can be applied.

FIG. 6 illustrates an example embodiment in which cascading operations can be applied.

FIG. 7 is a flow diagram that describes steps of a method in accordance with one or more embodiments.

FIG. 8 is a flow diagram that describes steps of a method in accordance with one or more embodiments.

FIG. 9 is a diagram that describes an implementation example in accordance with one or more embodiments.

FIG. 10 illustrates an example computing device that can be utilized to implement various embodiments described herein.

### DETAILED DESCRIPTION

### Overview

Various embodiments enable performant cascading operations to be performed by selectively applying a subset of cascading operations to designated elements in a hierarchical tree, responsive to receiving an input associated with one of the elements. A full set of cascading operations can be performed, subsequent to performing the subset of cascading operations, in accordance with various parameters.

In one or more embodiments, the subset of cascading operations can be determined, for the received input, based on parameters including, by way of example and not limitation, user interaction timing, the complexities of the cascading operations for a given element, and/or the number of elements to which the cascading operations can be applied, to name just a few.

In the following discussion, an example environment is first described that is operable to employ the techniques described herein. Example illustrations of the various embodiments are then described, which may be employed in the example environment, as well as in other environments. Accordingly, the example environment is not limited to performing the described embodiments and the described embodiments are not limited to implementation in the example environment.

### Example Operating Environment

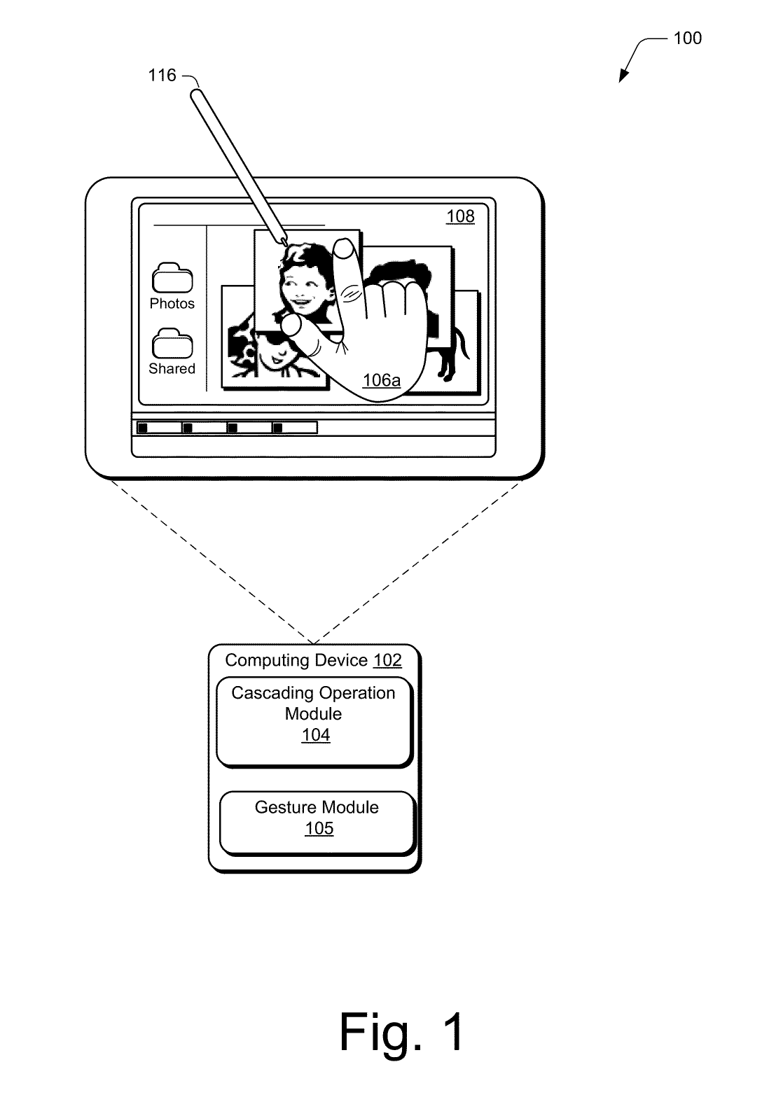

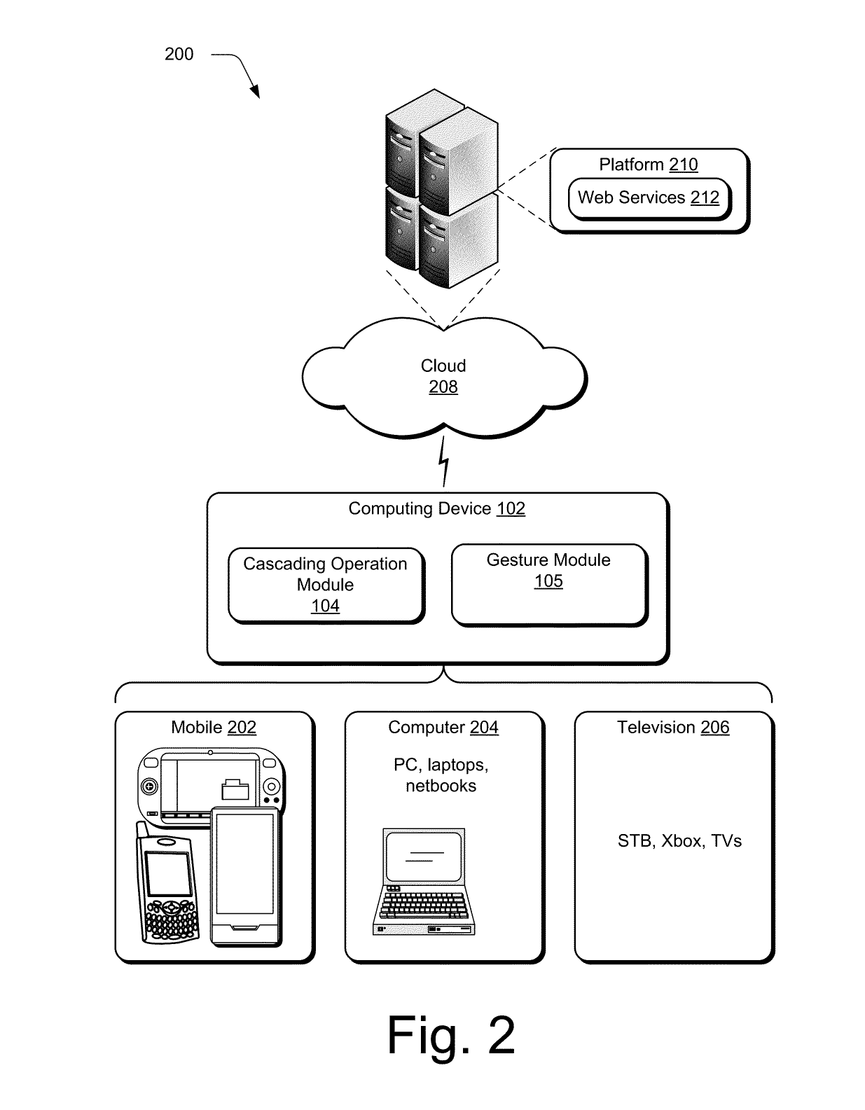

FIG. 1 is an illustration of an environment 100 in an example implementation that is operable to employ the techniques described in this document. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 includes a cascading operation module 104 configured to enable performant cascading operations to be performed in an efficient manner that is designed to enhance the user's experience as described in more detail below. In at least some embodiments, the cascading operation module 104 can make use of a timer or timers to measure the time associated with one or more received gestural inputs and, responsively, perform cascading operations. For example, in at least some embodiments the cascading operation module can enable performant cascading operations to be performed by selectively applying a subset of cascading operations to designated elements in a hierarchical tree, responsive to receiving an input, such as a gestural input, associated with one of the elements. A full set of cascading operations can then be performed, subsequent to performing the subset of cascading operations, in accordance with various parameters. The subset of cascading operations can be determined, for the received input, based on parameters including, by way of example and not limitation, user interaction timing, the complexities of the cascading operations for a given element, and/or the number of elements to which the cascading operations can be applied, to name just a few.

Computing device 102 also includes a gesture module 105 that recognizes input pointer gestures that can be performed by one or more fingers, and causes operations or actions to be performed that correspond to the gestures. The gestures may be recognized by module 105 in a variety of different ways. For example, the gesture module 105 may be configured to recognize a touch input, such as a finger of a user's hand 106a as proximal to display device 108 of the computing device 102 using touchscreen functionality, or functionality that senses proximity of a user's finger that may not necessarily be physically touching the display device 108, e.g., using near field technology. Module 105 can be utilized to recognize single-finger gestures and bezel gestures, multiple-finger/same-hand gestures and bezel gestures, and/or multiple-finger/different-hand gestures and bezel gestures. Although the cascading operation module 104 and gesture module 105 are depicted as separate modules, the functionality provided by both can be implemented in a single, integrated gesture module. The functionality implemented by modules 104 and/or 105 can be implemented by any suitably configured application such as, by way of example and not limitation, a web browser. Other applications can be utilized without departing from the spirit and scope of the claimed subject matter.

The computing device 102 may also be configured to detect and differentiate between a touch input (e.g., provided by one or more fingers of the user's hand 106a) and a stylus input (e.g., provided by a stylus 116). The differentiation may be performed in a variety of ways, such as by detecting an amount of the display device 108 that is contacted by the finger of the user's hand 106a versus an amount of the display device 108 that is contacted by the stylus 116.

Thus, the gesture module 105 may support a variety of different gesture techniques through recognition and leverage of a division between stylus and touch inputs, as well as different types of touch inputs and non-touch inputs.

FIG. 2 illustrates an example system 200 showing the cascading operation module 104 and gesture module 105 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses. Each of these configurations has a generally corresponding screen size and thus the computing device 102 may be configured as one of these device classes in this example system 200. For instance, the computing device 102 may assume the mobile 202 class of device which includes mobile telephones, music players, game devices, and so on. The computing device 102 may also assume a computer 204 class of device that includes personal computers, laptop computers, netbooks, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks.

The gesture techniques supported by the cascading operation module 104 and gesture module 105 may be detected using touchscreen functionality in the mobile configuration 202, track pad functionality of the computer 204 configuration, detected by a camera as part of support of a natural user interface (NUI) that does not involve contact with a specific input device, and so on. Further, performance of the operations to detect and recognize the inputs to identify a particular gesture may be distributed throughout the system 200, such as by the computing device 102 and/or the web services 212 supported by the platform 210 of the cloud 208.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

In the discussion that follows, various sections describe various example embodiments. A section entitled “Example Cascading Operations” describes embodiments in which cascading operations can be performed in accordance with one or more embodiments. Following this, a section entitled “Example Using Single Timer” describes an example in which a single timer can be used in accordance with one or more embodiments. Next, a section entitled “Example Using Multiple Timers” describes an example in which multiple timers can be used in accordance with one or more embodiments. Following this, a section entitled “Other Parameters” describes embodiments that can utilize other parameters, in addition to or separate from timing parameters, in order to perform cascading operations in accordance with one or more embodiments. Next, a section entitled “Example Methods” describes example methods in accordance with one or more embodiments. Last, a section entitled “Example Device” describes aspects of an example device that can be utilized to implement one or more embodiments.

Having described example operating environments in which performant cascading operation functionality can be utilized, consider now a discussion of an example embodiments.

### Example Cascading Operations

As noted above, various embodiments enable performant cascading operations to be performed by selectively applying a subset of cascading operations to designated elements in a hierarchical tree, responsive to receiving an input associated with one of the elements. A full set of cascading operations can be performed, subsequent to performing the subset of cascading operations, in accordance with various parameters. In one or more embodiments, the subset of cascading operations can be determined, for the received input, based on parameters including, by way of example and not limitation, user interaction timing, the complexities of the cascading operations for a given element, and/or the number of elements to which the cascading operations can be applied, to name just a few.

The embodiments described below can be applied to any type of operation that has a cascading effect. One type of cascading operation pertains to operations that result in a visualization that can be perceived by a user. These visualizations can be defined in any suitable way. But one way in which such visualizations can be defined is through the use of Cascading Style Sheets (CSS) that utilize pseudo-classes. Two example pseudo-classes are the :hover and :active pseudo-classes. It is to be appreciated and understood, however, that such CSS pseudo-classes constitute but one example of visualizations that can be the subject of the described embodiments and, more generally, cascading operations that can be applied to elements that appear within a hierarchical tree, such as a document object model (DOM) tree. As such, other cascading operations, including those that present visualizations, can be utilized without departing from the spirit and scope of the claimed subject matter.

With respect to the CSS pseudo-classes mentioned above, consider the following.

The CSS :hover and :active pseudo classes on a selector allow formats to be applied to any of the elements selected by the selector that are being hovered (pointed at) or activated (e.g. clicked or otherwise designated) or have descendent elements that are being hovered or activated. This behavior is typically implemented by “tunneling” the hover/active state up the ancestor tree from the element being designated by a pointing implement, whether the pointing implement is a user's finger (either touching a display screen or being placed in near proximity), a stylus, a mouse, or input received through a natural user interface. Therefore, any element in the ancestor tree of the designated element is also considered to be in the same hover/active state as the designated element.

For large document trees and complicated CSS selectors, determining which elements are in the hover state and applying the appropriate formats can be an expensive operation, as noted above. With touch, for example, user interactions are often extremely brief For example, taps on an element may be as short as a few dozen milliseconds from the time the user touches the screen until the time the user lifts. In many cases, the time it takes to apply formats due to :hover and :active selectors can actually exceed the duration of the user interaction. This causes the user to see the hover/active styles “blink” after a delay after their interaction.

In one or more embodiments, in order to provide visual feedback that is generally immediately perceived in response to the user's interaction, a portion of the tunneling operation can be done partially, in order to render a subset of the elements in the hover state. If, after some time or in association with other parameters, the user is still perceived by the system to be designating the element with the pointing device, then the hover/active state can be tunneled completely to apply to all of the ancestor elements.

For fast interactions, the user will see immediate visual feedback on the element designated, thus confirming that their touch interaction was successful. For lingering interactions that persist after a period of time, the user will see the full application of formats as expected.

Having considered some example cascading operations, consider now an example that employs the use of the single timer in order to enable performant cascading operations.

### Example Using Single Timer

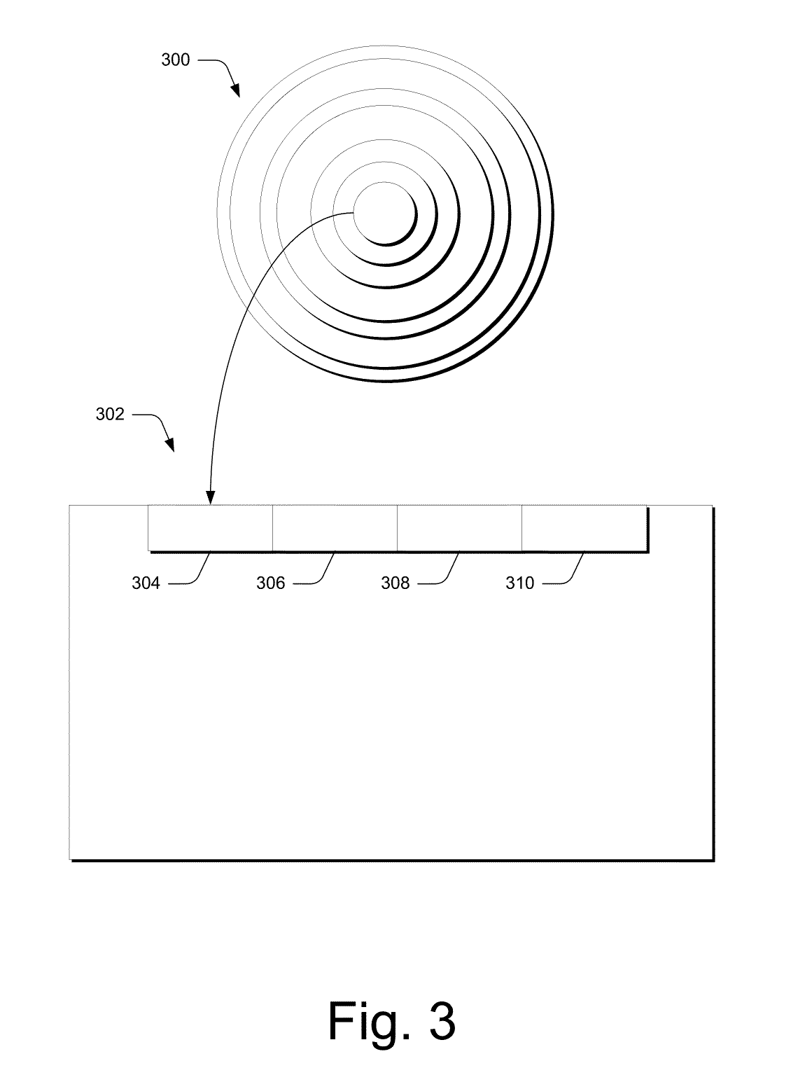

FIG. 3 is a diagrammatic representation that illustrates how cascading operations can be applied to a tree of elements in a DOM tree utilizing a single timer, in accordance with one or more embodiments. Consider first the collection of concentric circles illustrated generally at 300. In this example, each circle represents a particular element in a DOM tree. Each larger circle contains one or more circles and can be considered an ancestor of a contained circle. So, in this example, an example webpage is represented generally at 302. The webpage 302 includes a number of activatable elements at 304, 306, 308, and 310. The activatable elements represent items that might appear at the top of the webpage. Correspondingly, the inner-most circle represents element 304.

Consider also that for the elements represented by the collection of concentric circles, a cascading operation has been defined for element 304. This cascading operation can be tunneled up to the other ancestors of element 304 that appear in the DOM tree. In this particular example, assume that the cascading operation is defined through the use of the CSS :hover pseudo-class.

At this point, no input has been received with respect to any of the elements that appear in the webpage 302.

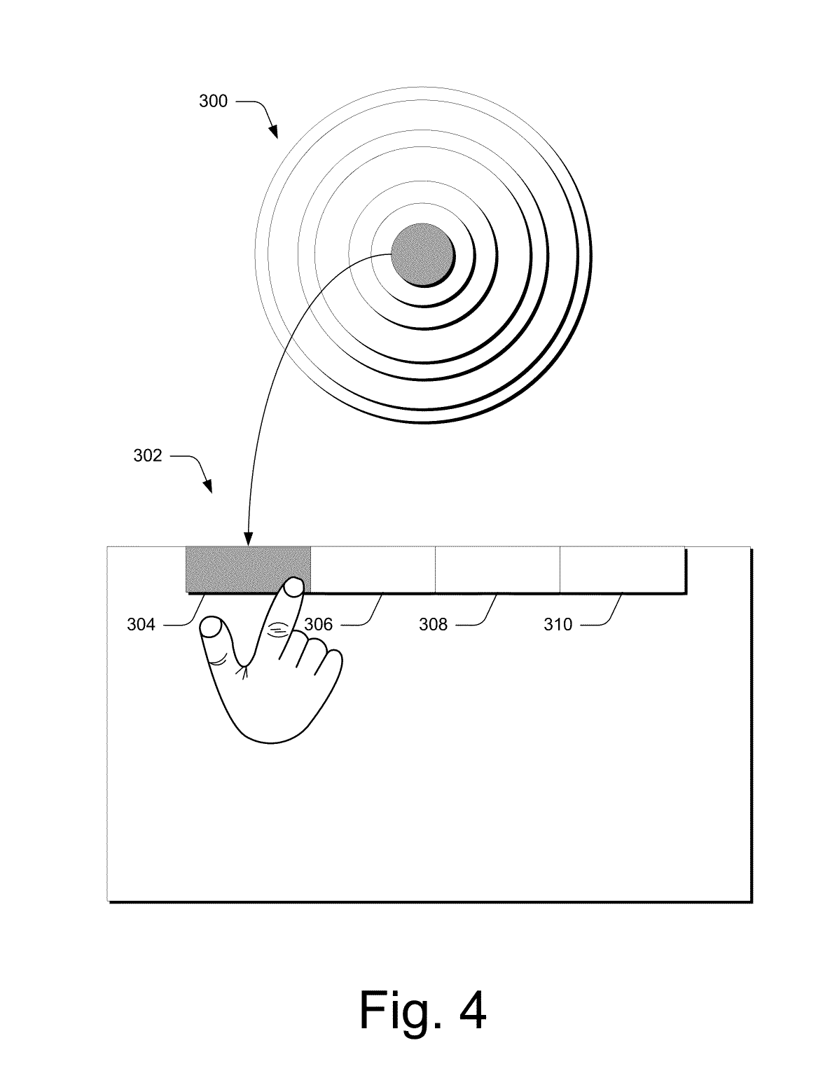

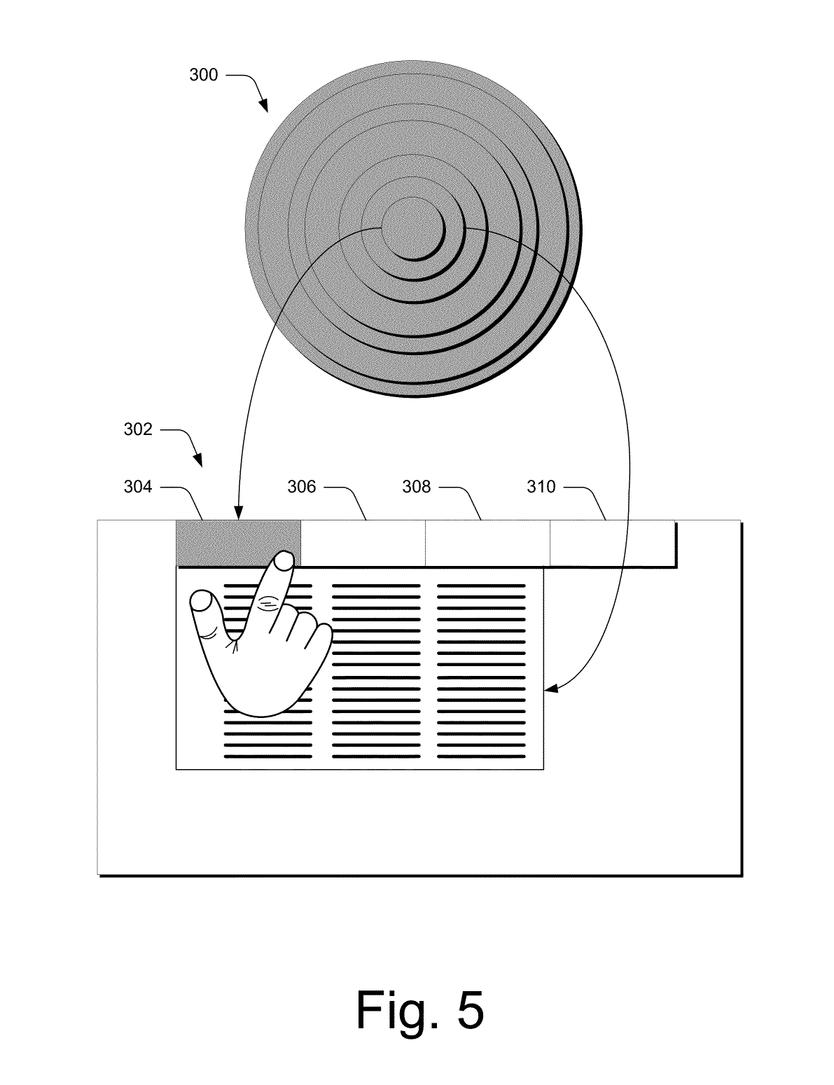

Assume now, in FIG. 4, that a user has hovered over element 304 as by, in this example, touching down on the element as indicated. Any suitable type of gestural input can, however, be utilized to invoke the hover functionality. Once input is received designating element 304, a single timer can be started and the hover style that has been defined for element 304 can be applied immediately. In this particular example, the hover style results in a color change to element 304 as indicated. If, after a period of time, e.g., a pre-defined time or a dynamically selectable time has passed, element 304 is still being designated by the gestural input, other ancestor elements of element 304 can have defined styles applied to them as well. As an example, consider FIG. 5.

There, element 304 retains its color change and, in addition, one or more of its ancestors in the DOM tree have a style defined by the :hover pseudo-class applied to them. In this particular example, one ancestor of element 304 is a menu of designatable items that now appears. Application of the defined style or styles can be applied to all of the ancestor elements that appear in a designated element's parent tree in the DOM tree.

In the illustrated and described embodiment, any suitable time, e.g., a pre-defined time, can be utilized. In at least some embodiments, a pre-defined time of 300 ms can be applied in order to enable performant cascading operations. In at least some embodiments, 300 ms can be used because studies have shown that almost all taps are less than 300 ms in duration.

If, on the other hand, within the time or pre-defined time the input designating element 304 is removed as by, for example, the user removing their finger from element 304, the styles are not applied to the collection of ancestor elements. In this manner, efficiencies are gained by virtue of progressively immersing the user in the style-defined visualization, without necessarily immediately applying the styles to all of the elements that appear within the designated element's DOM tree. In this way, a suitably-configured web browser (or other application) can provide a basic level of instantaneous visual feedback by rendering localized formats, while waiting for a period of time to decide whether to render other formats within the element's DOM tree. In addition, compatibility with the HTML/CSS programming model is maintained because longer user interactions, such as touch holding gestures, yield the full effect of an application's hover/active formats.

In this particular example, responsive to receiving input which designates element 304, the style format was applied initially to element 304 while, during the pendency of the timer, style formats defined for the element's ancestors were not applied. In at least some embodiments, upon designation of an element, the element's DOM tree can be traversed upwardly to identify a subset of elements that meet or exceed a defined number of elements. Initially, then, style formats defined for this subset of elements can be generally immediately applied while waiting for expiration of the timer to ascertain whether style formats are to be applied to other ancestors in the DOM tree.

### Example Using Multiple Timers

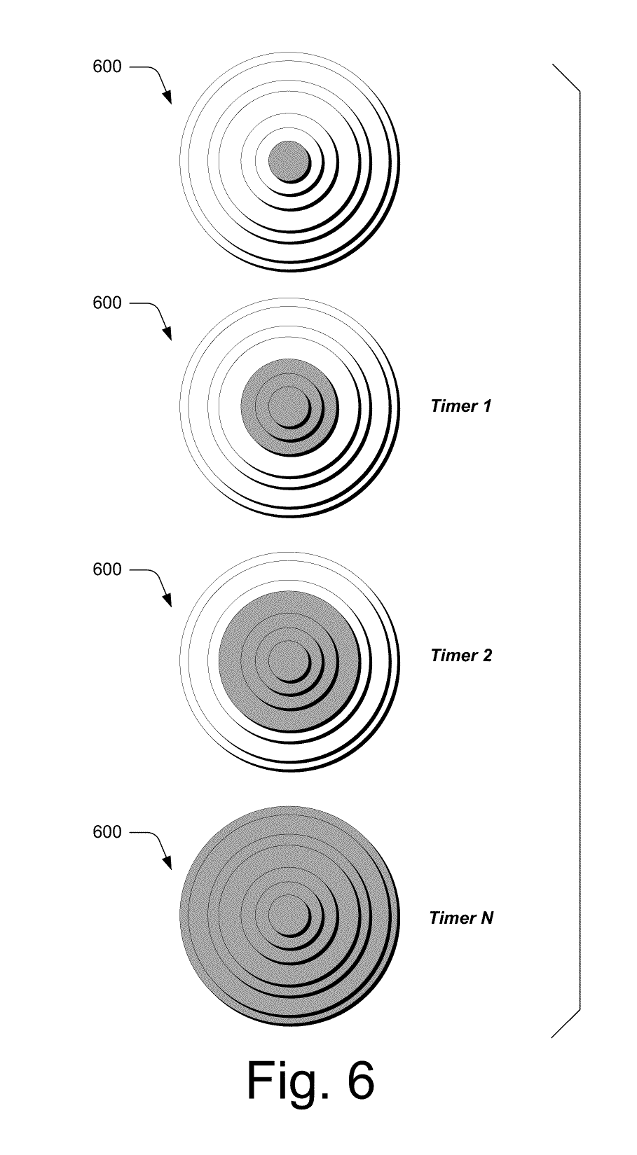

In one or more embodiments, multiple timers can be utilized in order to decide when to apply style formats that have been defined for ancestor elements that appear in a DOM tree associated with the designated element. As an example, consider FIG. 6 which shows a series of collections of concentric circles, each series of which is designated at 600. Each circle within a concentric collection represents an element in a DOM tree. Each individual collection of concentric circles represents the same plurality of elements that appear in a DOM tree associated with designated element at different times. Upon detecting input that designates a first element, a style format that has been defined for the first element can be applied. This is indicated by the top most collection of concentric circles where the innermost circle is shaded. When the first element is designated, a first timer is started. If after expiration of the first timer, the first element remains designated, as by being the subject of a hover selection, one or more additional ancestor elements can have style formats applied to them as well. This is indicated by the second collection of concentric circles where two additional circles are shaded. Upon expiration of a second timer, if the first element remains designated, one or more additional ancestor elements can have style formats applied to them as well. This is indicated by the third collection of concentric circles where additional circles are shaded. Upon expiration of an additional timer or timers, more ancestor elements can have style formats applied to them. This is indicated by the bottommost collection of concentric circles where all of the circles are shaded.

### Other Parameters

As noted above, parameters other than, or in addition to time parameters, can be utilized to ascertain how to progressively apply cascading operations. For example, in the timer-based approaches, the timers can be tunable to adapt to such things as how user input is received and/or a device's operating characteristics. For example, a timer might be tuned to account for the speed with which user input occur. Specifically, some users may provide input, such as tap inputs, more quickly than other users. In these instances, the timer or timers may be adjusted downwardly (or upwardly) to account for quicker (or slower) inputs. Alternately or additionally, devices that are perceived to have slower operating characteristics may have their associated timer or timers extended to account for the slower operating characteristics.

Alternately or additionally, various heuristics can be utilized to select the number of elements for which initial or subsequent style formats are to be applied. For example, some heuristics can consider how complicated application of the style formats will be on a per element or multi-element basis. Specifically, in these instances, a set number of elements may be selected for initial style format application based on data associated with how long application of the style formats typically takes. For example, using the pre-defined time of 300 ms for the initial timer, if, on average, an element takes 100 ms to have a style format applied, one might initially select the first two elements appearing in the DOM tree for which to apply style formats. This way, formats can be rendered with time remaining during the interaction for the user to perceive the visual feedback. If only one timer is used, then after expiration of the timer the remaining elements in the ancestral tree may be selected for style format application. In multiple-timer embodiments, after expiration of the initial timer, the next sub-set of elements elements appearing in the ancestral tree might be selected, and so on.

Alternately or additionally, instead of selecting a set number of elements for which to apply style formats, as the ancestral tree is traversed, a cost associated with applying style formats to particular elements can be computed. When the cost exceeds a certain threshold, application of the style formats can terminate. Any suitable parameters can be utilized for computing the cost including, by way of example and not limitation, generic units of work, CPU cycles, and the like.

Having considered example embodiments in which cascading operations can be performed, consider now some example methods in accordance with one or more embodiments.

### Example Methods

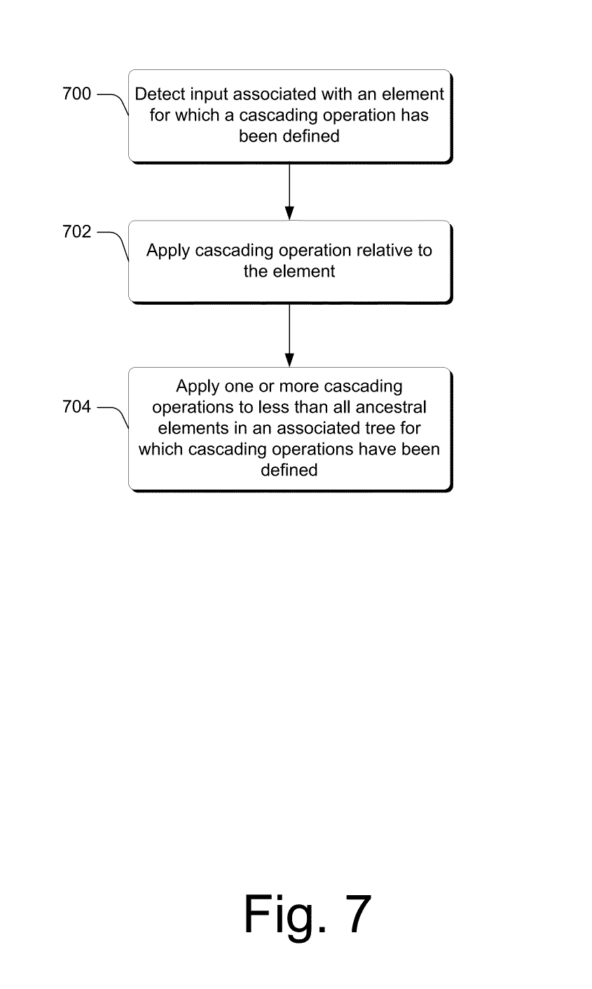

FIG. 7 is a flow diagram that describes steps in a method accordance with one or more embodiments. The method can be performed in connection with any suitable hardware, software, firmware, or combination thereof. In at least some embodiments, the method can be performed by software in the form of computer readable instructions, embodied on some type of computer-readable storage medium, which can be performed under the influence of one or more processors. Examples of software that can perform the functionality about to be described are the cascading operation module 104 and the gesture module 105 described above.

Step 700 detects input associated with an element for which a cascading operation has been defined. Any suitable type of input can be utilized. Such input can include, by way of example and not limitation, touch input such as can be received by way of a touch gesture or a stylus gesture. Alternately or additionally, such input can be received by way of a gesture provided through a natural user interface, a non-touch gesture such as that which can be ascertained through near field techniques, a mouse click, and the like. In addition, any suitable type of cascading operation can be utilized including, by way of example and not limitation, cascading operations that are defined through CSS pseudo-classes.

Step 702 applies a cascading operation relative to the element for which input was detected in step 700. Step 704 applies one or more cascading operations to less than all ancestral elements in an associated tree for which cascading operations have been defined. This step can be performed in any suitable way using any suitable type of parameters to ascertain elements for which to apply the cascading operations. Such parameters can include, by way of example and not limitation, a time-based parameters and/or parameters other than time-based parameters. In addition, after initially performing step 704, such step can be subsequently performed on additional elements and less than all of the ancestral elements in the associated tree or, alternately, on all remaining ancestral elements.

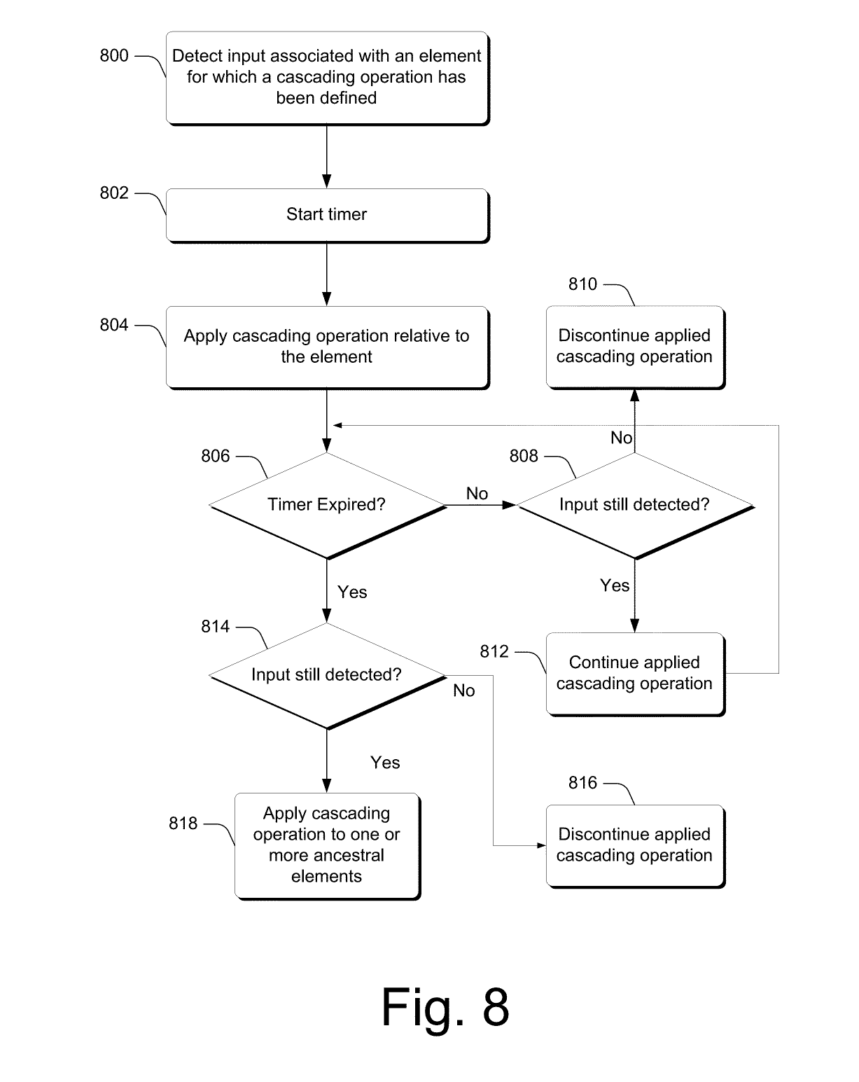

FIG. 8 is a flow diagram that describes steps in another method accordance with one or more embodiments. The method can be performed in connection with any suitable hardware, software, firmware, or combination thereof. In at least some embodiments, the method can be performed by software in the form of computer readable instructions, embodied on some type of computer-readable storage medium, which can be performed under the influence of one or more processors. Examples of software that can perform the functionality about to be described are the cascading operation module 104 and the gesture module 105 described above.

Step 800 detects input associated with an element for which a cascading operation has been defined. Any suitable type of input can be utilized. Such input can include, by way of example and not limitation, touch input such as can be received by way of a touch gesture or a stylus gesture. Alternately or additionally, such input can be received by way of a gesture provided through a natural user interface, a non-touch gesture such as that which can be ascertained through near field techniques, a mouse click, and the like. In addition, any suitable type of cascading operation can be utilized including, by way of example and not limitation, cascading operations that are defined through CSS pseudo-classes.

Step 802 starts a timer. Any suitable type of timer can be utilized, examples of which are provided above. Step 804 applies a cascading operation relative to the element for which input was detected at step 800. Step 806 ascertains whether the timer has expired. If the timer has not expired, step 808 ascertains whether the input from step 800 is still detected. If not, step 810 discontinues application of the cascading operation. If, on the other hand, the input is still detected at step 808, step 812 continues the applied cascading operation and returns to step 806.

If, at step 806, the timer has expired, step 814 ascertains whether the input from step 800 is still detected on the element. If not, step 816 discontinues the applied cascading operation. If, on the other hand, the input from step 800 is still detected, step 818 applies at least one cascading operation to one or more respective ancestral elements of the element for which the cascading operation was applied in step 804. The cascading operations applied by step 818 can be applied to a subset of the ancestral elements. Alternately or additionally, the cascading operations can be applied to all of the ancestral elements. Examples of how this can be done are provided above.

Having considered example methods in accordance with one or more embodiments, consider now an implementation example.

### Implementation Example

As noted above, in a web page, a user can use a pointing device or some other implement to designate an element. When an element is designated, that element is considered to be in the CSS “hover” state. Furthermore, also as noted above, CSS extends the definition to provide that if a given element is designated in the “hover state,” then all of its ancestors are also considered to be in the hover state. The process of propagating the “hover” state to the parents or ancestors of the designated element is known as “tunneling the hover.” Content authors can then use the :hover CSS pseudo-selector to apply style format rules to elements in the hover state. For example, the following CSS would apply a border to all DIV elements while they are in the hover state:

div:hover{border: 1 px solid black;}

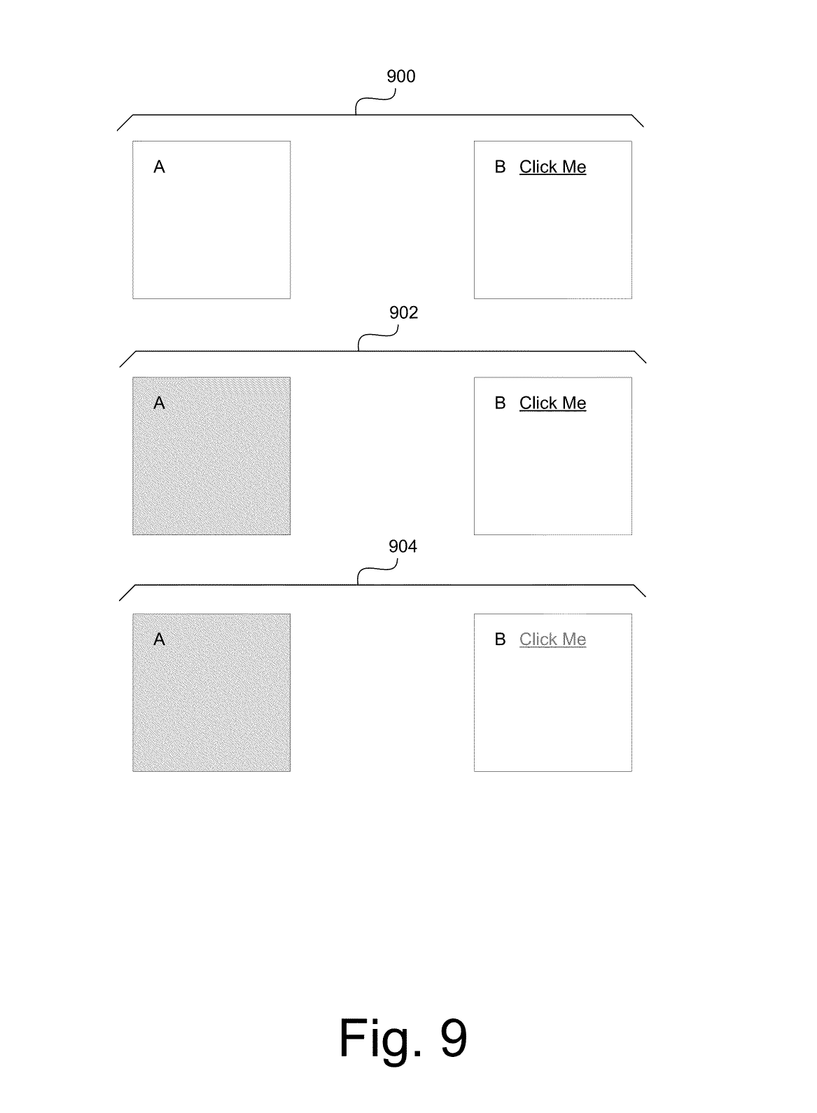

Note that a given element does not necessarily occupy a subset of the space occupied by its parent. For example, consider FIG. 9 in connection with the following code sample:

<!doctype html>
<html>

<head>

<title>CSS Hover</title>
<style>
div {

width: 200px;
height: 200px;
border: 1px solid black;

}
#B {

position: absolute;
right:0px;
top: 0px;

}
a:hover { color: red; }
#A:hover { background-color: blue; }
</style>

</head>
<body>

<div id=“A”>A

<div id=“B”>B

<a href=“#”>Click Me</a>

</div>

</div>

</body>

</html>

Here, in the top-most elements A and B designated at 900, element A is the parent element of element B. However, the elements occupy completely different spaces in the rendering. Because of this and because the CSS hover state tunnels, it is therefore possible for an element to have hover style formats despite not being specifically designated by the pointing device. When a user provides input with respect to element A, its format is applied as in the middle-most elements A and B designated at 902. Now, if a user designates the “Click Me” link in element B as in the bottom-most elements A and B designated at 904, such causes a format to be applied to the “Click Me” link and for the background-color format in the hover rule for element A to be applied.

Using the above-described approaches, the “Click Me” link's hover styles are applied initially and then the ancestral hover styles (for B and A) are applied after a timer. In one embodiment, a single element is used in the initial format application.

Having considered an implementation example, consider now an example device that can be utilized to implement one or more embodiments as described above.

### Example Device

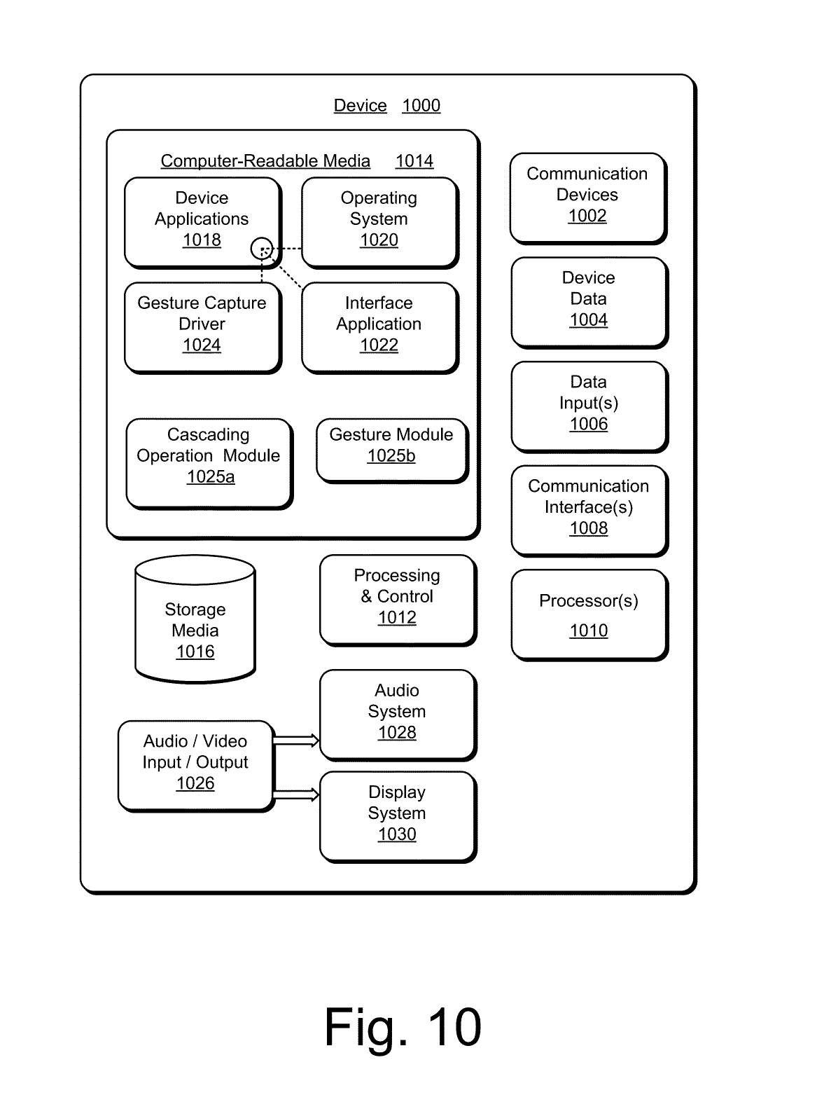

FIG. 10 illustrates various components of an example device 1000 that can be implemented as any type of portable and/or computer device as described with reference to FIGS. 1 and 2 to implement embodiments of the animation library described herein. Device 1000 includes communication devices 1002 that enable wired and/or wireless communication of device data 1004 (e.g., received data, data that is being received, data scheduled for broadcast, data packets of the data, etc.). The device data 1004 or other device content can include configuration settings of the device, media content stored on the device, and/or information associated with a user of the device. Media content stored on device 1000 can include any type of audio, video, and/or image data. Device 1000 includes one or more data inputs 1006 via which any type of data, media content, and/or inputs can be received, such as user-selectable inputs, messages, music, television media content, recorded video content, and any other type of audio, video, and/or image data received from any content and/or data source.

Device 1000 also includes communication interfaces 1008 that can be implemented as any one or more of a serial and/or parallel interface, a wireless interface, any type of network interface, a modem, and as any other type of communication interface. The communication interfaces 1008 provide a connection and/or communication links between device 1000 and a communication network by which other electronic, computing, and communication devices communicate data with device 1000.

Device 1000 includes one or more processors 1010 (e.g., any of microprocessors, controllers, and the like) which process various computer-executable or readable instructions to control the operation of device 1000 and to implement the embodiments described above. Alternatively or in addition, device 1000 can be implemented with any one or combination of hardware, firmware, or fixed logic circuitry that is implemented in connection with processing and control circuits which are generally identified at 1012. Although not shown, device 1000 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1000 also includes computer-readable media 1014, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1000 can also include a mass storage media device 1016.

Computer-readable media 1014 provides data storage mechanisms to store the device data 1004, as well as various device applications 1018 and any other types of information and/or data related to operational aspects of device 1000. For example, an operating system 1020 can be maintained as a computer application with the computer-readable media 1014 and executed on processors 1010. The device applications 1018 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 1018 also include any system components or modules to implement embodiments of the techniques described herein. In this example, the device applications 1018 include an interface application 1022 and a gesture-capture driver 1024 that are shown as software modules and/or computer applications. The gesture-capture driver 1024 is representative of software that is used to provide an interface with a device configured to capture a gesture, such as a touchscreen, track pad, camera, and so on. Alternatively or in addition, the interface application 1022 and the gesture-capture driver 1024 can be implemented as hardware, software, firmware, or any combination thereof. In addition, computer readable media 1014 can include a cascading operation module 1025a and a gesture module 1025b that functions as described above.

Device 1000 also includes an audio and/or video input-output system 1026 that provides audio data to an audio system 1028 and/or provides video data to a display system 1030. The audio system 1028 and/or the display system 1030 can include any devices that process, display, and/or otherwise render audio, video, and image data. Video signals and audio signals can be communicated from device 1000 to an audio device and/or to a display device via an RF (radio frequency) link, S-video link, composite video link, component video link, DVI (digital video interface), analog audio connection, or other similar communication link. In an embodiment, the audio system 1028 and/or the display system 1030 are implemented as external components to device 1000. Alternatively, the audio system 1028 and/or the display system 1030 are implemented as integrated components of example device 1000.

### CONCLUSION

Various embodiments enable performant cascading operations to be performed by selectively applying a subset of cascading operations to designated elements in a hierarchical tree, responsive to receiving an input associated with one of the elements. A full set of cascading operations can be performed, subsequent to performing the subset of cascading operations, in accordance with various parameters.

In one or more embodiments, the subset of cascading operations can be determined, for the received input, based on parameters including, by way of example and not limitation, user interaction timing, the complexities of the cascading operations for a given element, and/or the number of elements to which the cascading operations can be applied, to name just a few.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A method comprising:
detecting an input associated with an element for which a cascading operation has been defined;
applying the cascading operation to the element; and
applying one or more cascading operations to less than all ancestral elements, in an associated tree, for which cascading operations have been defined.

2. The method of claim 1, wherein said detecting comprises detecting a touch input.

3. The method of claim 1, wherein said detecting comprises detecting a non-touch input.

4. The method of claim 1, wherein said cascading operation comprises a cascading operation defined through at least one CSS pseudo-class.

5. The method of claim 1, wherein applying said one or more cascading operations is performed by using a time-based parameter to ascertain when to apply said one or more cascading operations.

6. The method of claim 1, wherein applying said one or more cascading operations is performed by at least using a parameter other than a time-based parameter to ascertain ancestral elements to which apply said one or more cascading operations.

7. The method of claim 1 further comprising after applying said one or more cascading operations, applying one or more additional cascading operations to additional ancestral elements.

8. The method of claim 1 further comprising after applying said one or more cascading operations, applying one or more additional cascading operations to all additional ancestral elements.

9. One or more computer readable storage media embodying computer readable instructions which, when executed, implement a method comprising:
detecting an input associated with an element for which a cascading operation has been defined;
responsive to said detecting, starting a timer;
applying the cascading operation to the element;
responsive to the timer expiring and said input still being detected, applying at least one cascading operation to one or more respective ancestral elements of said element for which input was detected.

10. The one or more computer readable storage media of claim 9, wherein said detecting comprises detecting a touch input.

11. The one or more computer readable storage media of claim 9, wherein said detecting comprises detecting a non-touch input.

12. The one or more computer readable storage media of claim 9, wherein said cascading operation comprises a cascading operation defined through at least one CSS pseudo-class.

13. The one or more computer readable storage media of claim 9, wherein said applying at least one cascading operation comprises applying said at least one cascading operation to a subset of ancestral elements of said element for which input was detected.

14. The one or more computer readable storage media of claim 9, wherein said applying at least one cascading operation comprises applying said at least one cascading operation to all ancestral elements of said element for which input was detected.

15. The one or more computer readable storage media of claim 9 further comprising using at least one additional timer to ascertain when to apply cascading operations to at least some ancestral elements.

16. A system comprising:
a cascading operation module configured to:
apply a subset of cascading operations to at least a designated element in a document object model (DOM) tree; and
after expiration of at least one timer, apply additional cascading operations to at least some other ancestral elements of the designated element.

17. The system of claim 16, wherein the cascading operations are defined by at least one CSS pseudo-class.

18. The system of claim 16, wherein the cascading operations comprise visualizations.

19. The system of claim 16, wherein the system further comprises one or more computer readable storage media and the cascading operation module is implemented in software embodied on the one or more computer readable storage media.

20. The system of claim 16, wherein the system further comprises one or more processors and a display device, and wherein the cascading operation module is configured to operate under the influence of the one or more processors to cause a visualization of at least some applied cascading operations on the display device.
